(19) United States
(12) Patent Application Publication
(10) Pub. No.: US 2014/0089803 A1
(43) Pub. Date: Mar. 27, 2014

(54) SEEK TECHNIQUES FOR CONTENT PLAYBACK

(71) Applicants: John C. Weast, Portland, OR (US); Melissa O'Neill, Claremont, CA (US); Christopher R. Beavers, Bee Cave, TX (US); Dinh Tu R. Truong, Long Beach, CA (US); Jia-Shi Zhang, Camarillo, CA (US); Richard S. Porczak, San Luis Obispo, CA (US)

(72) Inventors: John C. Weast, Portland, OR (US); Melissa O'Neill, Claremont, CA (US); Christopher R. Beavers, Bee Cave, TX (US); Dinh Tu R. Truong, Long Beach, CA (US); Jia-Shi Zhang, Camarillo, CA (US); Richard S. Porczak, San Luis Obispo, CA (US)

(21) Appl. No.: 13/628,299

(22) Filed: Sep. 27, 2012

(51) Int. Cl. G06F 3/00

(52) U.S. Cl. CPC G06F 3/00
USPC 715/721

(57) ABSTRACT

Improved seek techniques for content playback are described. In one embodiment, for example, an apparatus may comprise a processor circuit and a content management module, and the content management module may be operable by the processor circuit to determine a seek destination comprising an event within a content item, identify a time index value corresponding to the event, and initiate playback of the content item at the time index value. In this manner, improved seek results may be realized that allow users to seek to specific events or points of interest within consumed content. Other embodiments are described and claimed.

### BACKGROUND

Conventional techniques for providing seek functionality to consumers of video and/or audio content are largely linear in nature, offering content consumers merely the ability to jump backwards or forwards within such content by discrete time intervals or high level chapters. However, the purposes of consumer seek operations may often be poorly served by such functionality. For example, a consumer of video content may wish to seek backwards to the beginning of a previous line of dialog that he missed, but according to conventional seek techniques, may be forced to seek backwards by a discrete amount of time to a point significantly earlier than the beginning of the previous line of dialog. As a result, the consumer may be required to re-watch portions of the video that he did not wish to review. Accordingly, improved seek techniques for content playback may be desirable.

### BRIEF DESCRIPTION OF THE DRAWINGS

FIG. 1 illustrates one embodiment of an apparatus and one embodiment of a first system.

FIG. 2 illustrates one embodiment of a content description database.

FIG. 3 illustrates one embodiment of a first logic flow.

FIG. 4 illustrates one embodiment of a second logic flow.

FIG. 5 illustrates one embodiment of a third logic flow.

FIG. 6 illustrates one embodiment of a second system.

FIG. 7 illustrates one embodiment of a third system.

FIG. 8 illustrates one embodiment of a device.

### DETAILED DESCRIPTION

Various embodiments may be generally directed to improved seek techniques for content playback. In one embodiment, for example, an apparatus may comprise a processor circuit and a content management module, and the content management module may be operable by the processor circuit to determine a seek destination comprising an event within a content item, identify a time index value corresponding to the event, and initiate playback of the content item at the time index value. In this manner, improved seek results may be realized that allow users to seek to specific events or points of interest within consumed content. Other embodiments are described and claimed.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrases “in one embodiment,” “in some embodiments,” and “in various embodiments” in various places in the specification are not necessarily all referring to the same embodiment.

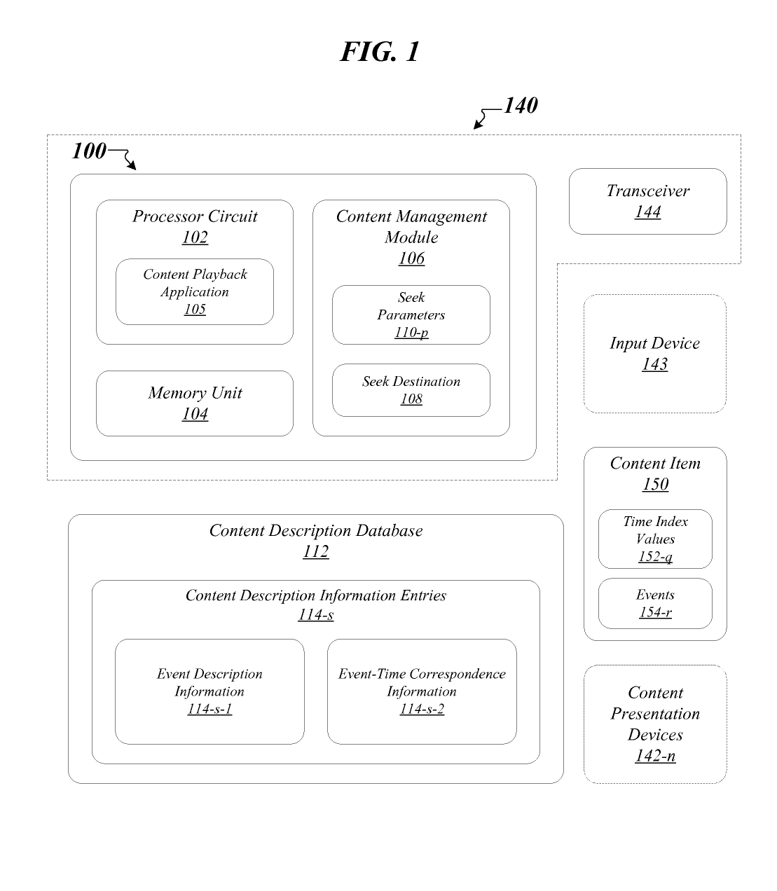

FIG. 1 illustrates a block diagram of an apparatus 100. As shown in FIG. 1, apparatus 100 comprises multiple elements including a processor circuit 102, a memory unit 104, and a content management module 106. The embodiments, however, are not limited to the type, number, or arrangement of elements shown in this figure.

In various embodiments, apparatus 100 may comprise processor circuit 102. Processor circuit 102 may be implemented using any processor or logic device, such as a complex instruction set computer (CISC) microprocessor, a reduced instruction set computing (RISC) microprocessor, a very long instruction word (VLIW) microprocessor, an x86 instruction set compatible processor, a processor implementing a combination of instruction sets, a multi-core processor such as a dual-core processor or dual-core mobile processor, or any other microprocessor or central processing unit (CPU). Processor circuit 102 may also be implemented as a dedicated processor, such as a controller, a microcontroller, an embedded processor, a chip multiprocessor (CMP), a co-processor, a digital signal processor (DSP), a network processor, a media processor, an input/output (I/O) processor, a media access control (MAC) processor, a radio baseband processor, an application specific integrated circuit (ASIC), a field programmable gate array (FPGA), a programmable logic device (PLD), and so forth. In one embodiment, for example, processor circuit 102 may be implemented as a general purpose processor, such as a processor made by Intel® Corporation, Santa Clara, Calif. The embodiments are not limited in this context.

In some embodiments, apparatus 100 may comprise or be arranged to communicatively couple with a memory unit 104. Memory unit 104 may be implemented using any machine-readable or computer-readable media capable of storing data, including both volatile and non-volatile memory. For example, memory unit 104 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy of note that some portion or all of memory unit 104 may be included on the same integrated circuit as processor circuit 102, or alternatively some portion or all of memory unit 104 may be disposed on an integrated circuit or other medium, for example a hard disk drive, that is external to the integrated circuit of processor circuit 102. Although memory unit 104 is comprised within apparatus 100 in FIG. 1, memory unit 104 may be external to apparatus 100 in some embodiments. The embodiments are not limited in this context.

In various embodiments, processor circuit 102 may be operable to execute a content presentation application 105. Content presentation application 105 may comprise any application featuring content presentation capabilities, such as, for example, a streaming video and/or audio presentation application, a broadcast video and/or audio presentation application, a DVD and/or Blue-Ray presentation application, a CD presentation application, a digital video file presentation application, a digital audio file presentation application, a conferencing application, a gaming application, a productivity application, a social networking application, a web browsing application, and so forth. While executing, content presentation application 105 may be operative to present video and/or audio content such as streaming video and/or audio, broadcast video and/or audio, video and/or audio content contained on a disc or other removable storage medium, and/or video and/or audio content contained in a digital video file and/or digital audio file. The embodiments, however, are not limited in this respect.

In some embodiments, apparatus 100 may comprise a content management module 106. Content management module 106 may comprise logic, circuitry, information, and/or instructions operative to manage the presentation of video and/or audio content. In various embodiments, content management module 106 may comprise programming logic within content presentation application 105. In other embodiments, content management module 106 may comprise logic, circuitry, information, and/or instructions external to content presentation application 105, such as a driver, a chip and/or integrated circuit, or programming logic within another application or an operating system. The embodiments are not limited in this context.

FIG. 1 also illustrates a block diagram of a system 140. System 140 may comprise any of the aforementioned elements of apparatus 100. System 140 may further comprise a transceiver 144. Transceiver 144 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, transceiver 144 may operate in accordance with one or more applicable standards in any version. The embodiments are not limited in this context.

In some embodiments, apparatus 100 and/or system 140 may be configurable to communicatively couple with one or more content presentation devices 142-n. Content presentation devices 142-n may comprise any devices capable of presenting video and/or audio content. Examples of content presentation devices 142-n may include displays capable of displaying information received from processor circuit 102, such as a television, a monitor, a projector, and a computer screen. In one embodiment, for example, a content presentation device 142-n may comprise a display implemented by a liquid crystal display (LCD), light emitting diode (LED) or other type of suitable visual interface, and may comprise one or more thin-film transistors (TFT) LCDs including embedded transistors. Examples of content presentation devices 142-n may also include audio playback devices and/or systems capable of generating tones, music, speech, speech utterances, sound effects, background noise, or other sounds, such as a speaker, a multi-speaker system, and/or a home entertainment system. Examples of content presentation devices 142-n may also include devices capable of playing back both video and audio, such as a television, a consumer appliance, a computer system, a mobile device, and/or a portable electronic media device. The embodiments are not limited to these examples.

In various embodiments, apparatus 100 may comprise or be arranged to communicatively couple with an input device 143. Input device 143 may be implemented using any device that enables apparatus 100 to receive user inputs. Examples of input device 143 may include a remote control, a mouse, a touch pad, a speech recognition device, a joystick, a keyboard, a camera, a motion detection device, and a gesture detection and/or recognition device. In some embodiments, a content presentation device 142-n may comprise a display arranged to display a graphical user interface operable to directly or indirectly control content presentation application 105. In various such embodiments, the graphical user interface may be manipulated according to control inputs received via input device 143. The embodiments are not limited in this context.

In general operation, apparatus 100 and/or system 140 may be operative to implement and/or manage the presentation of content 150 on one or more content presentation devices 142-n. More particularly, apparatus 100 and/or system 140 may be operative to implement improved seek techniques for the presentation of content 150. In some embodiments, content 150 may comprise video content, audio content, and/or a combination of both. Some examples of content 150 may include a motion picture, a play, a skit, a newscast, sporting event, or other television program, an image sequence, a video capture, a musical composition, a song, and/or a soundtrack. The embodiments are not limited to these examples. In various embodiments, content 150 may be comprised within a video and/or audio stream accessible by apparatus 100 and/or system 140, within information on a removable storage medium such as a CD, DVD, or Blu-Ray disc, within a digital video and/or audio file stored in memory unit 104 or in an external storage device, and/or within broadcast information received via transceiver 144. The embodiments are not limited to these examples.

In some embodiments, apparatus 100 and/or system 140, or a device external thereto, may be operative to define time index values 152-q for content 150. Each time index value 152-q may correspond to a portion of content 150 that is to be presented at a particular point in time relative to the start of content playback when content 150 is played back from start to finish. For example, if content 150 is a motion picture, a particular time index value 152-q associated with content 150 that has a value equal to five seconds may correspond to visual effects and/or sounds that are presented when five seconds have elapsed from the start of ongoing playback. In various embodiments, time index values 152-q may have an associated granularity that defines an incremental amount of time by which each subsequent time index value 152-q exceeds its previous time index value 152-q. For example, time index values 152-q may have an associated granularity of 1/100^{th} of a second. In such an example, a first time index value 152-q associated with particular content 150 may have a value (in h:mm:ss.ss format) of 0:00:00.00, a second time index value 152-q may have value of 0:00:00.01, a third time index value may have a value of 0:00:00.02, and so forth. The embodiments are not limited to these examples.

In some embodiments, one or more events 154-r may be identified and/or defined that correspond to noteworthy occurrences and/or effects within content 150. Examples of events 154-r may include, without limitation, lines of dialog, the entry and/or exit of characters and/or actors on screen, scene changes, changes of scene location, screen fades, the presence of objects, the appearance by characters in clothing and/or costumes of a particular type, brand, and/or color, beginnings and/or endings of songs or audio effects, plot developments, and any other occurrences and/or effects. Each event 154-r in particular content 150 may occur or commence at, or most near to, a particular time index value 152-q, and thus may be regarded as corresponding to that time index value 152-q. For example, an event 154-r that comprises the entry of a character onto the screen in content 150 comprising a motion picture at time index value 0:51:45.35 may be regarded as corresponding to the time index value 0:51:45.35. As such, information identifying a particular event 154-r may be useable to determine a particular time index value 152-q, based on the correspondence of the event 154-r to the time index value 152-q. The embodiments are not limited in this context.

In various embodiments, during presentation of content 150 on a content presentation device 142-n, content management module 106 may be operable to perform automatic seek operations and/or guided seek operations. Automatic seek operations may comprise seek operations that are performed automatically in response to the receipt of a predefined input via input device 143. For example, an automatic seek operation may comprise a backward seek performed in response to a pressing of a “jump back” button on a remote control. Guided seek operations may comprise seek operations that are defined and performed interactively with a user, based on descriptive information, keywords, and/or selections entered via input device 143. For example, a user may press a button on a remote control to initiate a search feature, and enter the name of a character appearing in content 150 using a graphical user interface. Apparatus 100 and/or system 140 may generate and present, via the graphical user interface, a list of events 154-r comprising lines of dialog spoken by that character. The user may then initiate a guided seek operation by selecting a particular line of dialog to which a seek is to be performed. The embodiments are not limited to this example.

In some embodiments, content management module 106 may be operative to receive, determine, or generate a seek destination 108. Seek destination 108 may comprise information identifying a particular event 154-r within content 150. For example, a seek destination 108 may comprise a particular line of dialog. In various such embodiments, a seek destination 108 may be determined or generated in conjunction with an automatic seek operation or a guided seek operation initiated based on input received via input device 143. In some embodiments, content presentation application 105 may be operative to generate a seek destination 108, and content management module 106 may receive the seek destination 108 from content presentation application 105. In various embodiments, content management module 106 may be operative to generate or determine a seek destination 108 based on information received from content presentation application 105 and/or one or more external components. In some embodiments, one or more components external to apparatus 100 and/or system 140 may be operative to generate a seek destination 108, and content management module 106 may receive the seek destination 108 from the one or more external components. The embodiments are not limited in this context.

In various embodiments, content management module 106 may be operative to interpret input received via input device 143 based on one or more seek parameters 110-p in order to determine seek destination 108 based on the received input. Some seek parameters 110-p may comprise parameters defining a particular type or subset of events 154-r between which automatic seek operations should traverse. For example, input device 143 may comprise a “skip back” button and a “skip forward” button, and a seek parameter 110-p may indicate that the skip back and skip forward buttons, when pressed, will initiate seeks to an immediately previous line of dialog and an immediately subsequent line of dialog, respectively. Other seek parameters 110-p may comprise parameters describing characteristics of events 154-r to be presented for selection in a graphical user interface in conjunction with a guided seek operation. In an example embodiment, input may be received via input device 143 that identifies a particular character in content 150, in conjunction with a search feature. Content management module 106 may then generate a seek parameter 110-p indicating that a search for events 154-r should return events 154-r that comprise lines of dialog spoken by that character. In some embodiments, content management module 106 may be operative to generate seek parameters 100-p itself, to receive seek parameters 100-p from content presentation application 105 and/or from one or more other internal or external components, or to both generate some seek parameters 100-p and receive other seek parameters 100-p. The embodiments are not limited in this context.

In various embodiments, content management module 106 may be operative to identify a time index value 152-q based on seek destination 108 and on a content description information entry 114-s in a content description database 112. Content description database 112 may comprise one or more content description information entries 114-s, each of which may comprise event description information 114-s-1 and event-time correspondence information 114-s-2. Event description information 114-s-1 may comprise information identifying a particular event 154-r and characteristics associated with that event 154-r. For example, event description information 114-s-1 may comprise information identifying an event 154-r comprising a particular line of dialog, and may comprise information identifying a character uttering that line of dialog and the words spoken thereby. Event-time correspondence information 114-s-2 may comprise information identifying a time index value 152-q corresponding to the event 154-r identified by the event description information 114-s-1. For example, event-time correspondence information 114-s-2 may comprise information identifying a time index value 152-q corresponding to an event 154-r comprising a line of dialog. The embodiments are not limited to these examples.

It is worthy of note that although content description database 112 is illustrated in FIG. 1 as being external to apparatus 100, system 140, and content item 150, the embodiments are not so limited. It is also worthy of note that content description database 112 and content item 150 need not necessarily be stored or reside at the same location. In some embodiments, either content item 150, content description database 112, or both may be stored in memory unit 104, stored on an external removable storage medium such as a DVD, stored on an external non-removable storage medium such as a hard drive, or stored at a remote location and accessible over one or more wired and/or wireless network connections. In an example embodiment, content item 150 may comprise a motion picture stored on a DVD, content description database 112 may be stored on that same DVD, and apparatus 100 and/or system 140 may be operative to access both content item 150 and content description database 112 by accessing that DVD. In another example embodiment, content item 150 may comprise a motion picture stored on a DVD, and content description database 112 may reside on a remote server and may be accessible via one or more wired and/or wireless network connections. In yet another example embodiment, content item 150 may comprise a motion picture stored on a remote server and accessible via one or more wired and/or wireless network connections, and content description database 112 may be stored in memory unit 104. In still another example embodiment, both content item 150 and content description database 112 may reside on a remote server and may be accessible via one or more wired and/or wireless network connections. The embodiments are not limited to these examples.

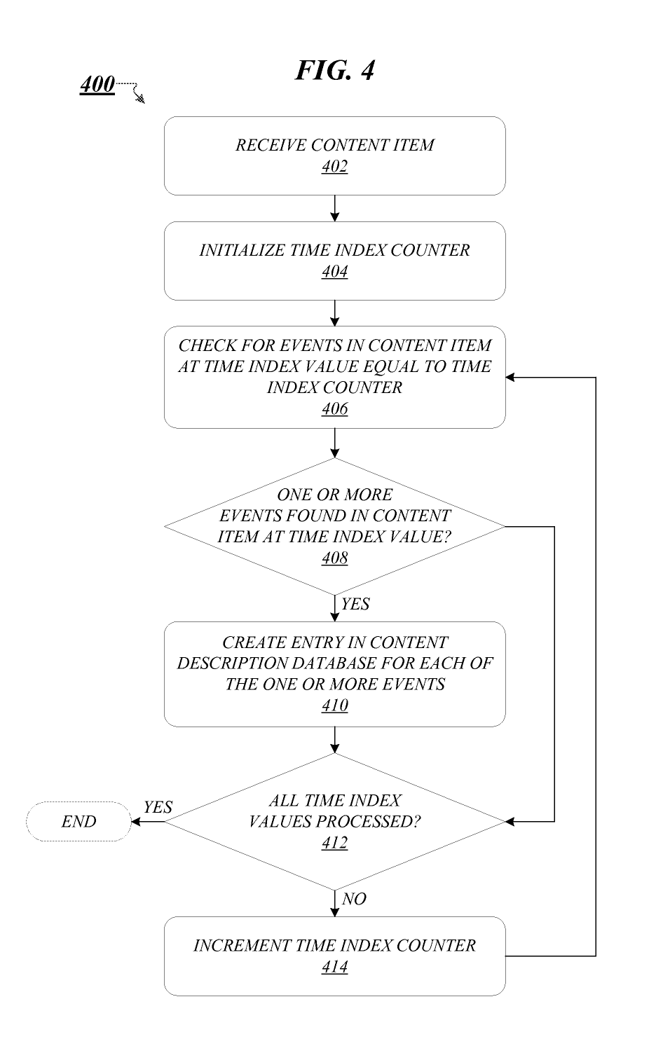

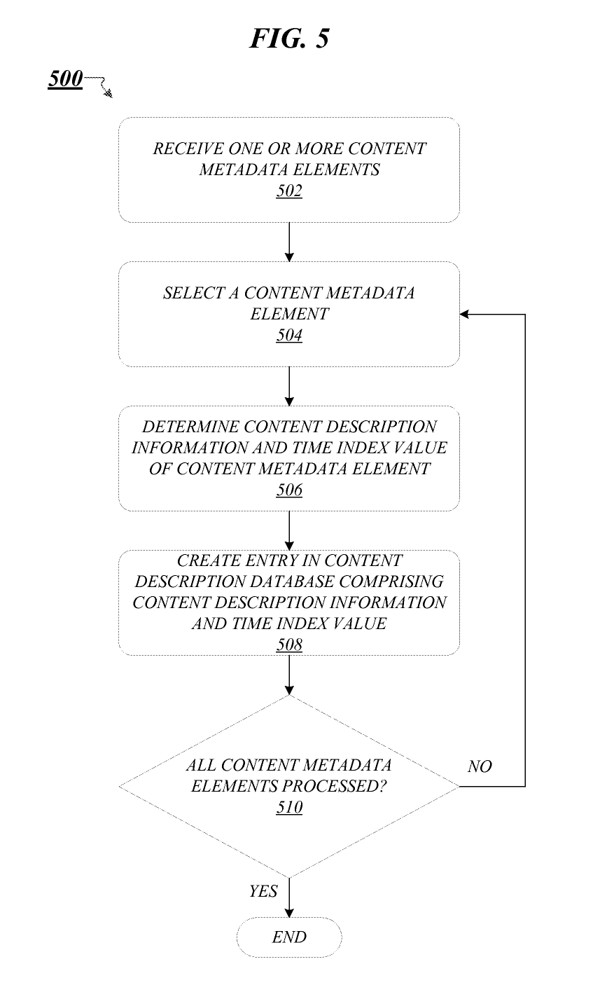

It is further worthy of note that in various embodiments, rather than accessing content description database 112 from an external source, apparatus 100 and/or system 140 may be operative to generate content description database 112 by processing content item 150 and/or content metadata elements associated with content item 150. Operations associated with the generation of content description database 112 are discussed below in reference to FIGS. 4 and 5.

In some embodiments, content management module 106 may be operative to identify a time index value 152-q based on seek destination 108 by searching content description database 112 for a content description information entry 114-s comprising event description information 114-s-1 that identifies an event 154-r that matches seek destination 108, and then determining the time index value 152-q identified by the event-time correspondence information 114-s-2 in the content description information 114-s. In an example embodiment, seek destination 108 may identify an event 154-r comprising a line of dialog, and content management module 106 may locate within content description database 112 a content description information entry 114-s comprising event description information 114-s-1 that identifies an event 154-r comprising that line of dialog. Content management module may then identify the time index value 152-q by determining the time index value 152-q identified in the event-time correspondence information 114-s-2 within the located content description information entry 114-s. The embodiments are not limited to this example.

In various embodiments, content management module may be operative to initiate playback of content 150 starting at the determined time index value 152-q, and thus beginning with the event 154-r corresponding to time index value 152-q. In some embodiments, apparatus 100 and/or system 140 may be operative on one or content presentation devices 142-n to present content 150 beginning with the event 154-r. The embodiments are not limited in this context.

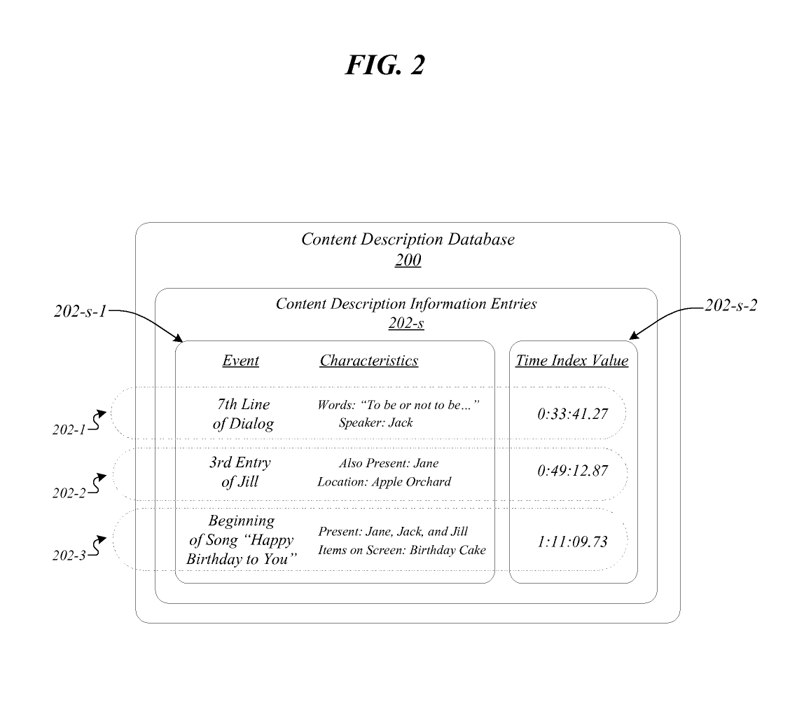

FIG. 2 illustrates one embodiment of a content description database 200 such as may be comprised by content description database 112 of FIG. 1. As shown in FIG. 2, content description database 200 comprises content description information entries 202-s, which in turn comprise event description information 202-s-1 and event-time correspondence information 202-s-2. For example, content description information entry 202-1 comprises event description information 202-1-1 identifying an event comprising a seventh line of dialog, and indicates that this line of dialog is spoken by the character Jack and comprises the words “to be or not to be . . . ” Content description information entry 202-1 also comprises event-time correspondence information 202-1-2 indicating that the event identified by event description information 202-1-1 occurs at time index value 0:33:41.27. With reference to FIG. 1, in various embodiments, content management module 106, content presentation application 105, and/or one or more external components may be operative to determine a seek destination 108 based on content description information entries 202-s in conjunction with an automatic seek operation. In an example embodiment, a user viewing a content item 150 on a content presentation device 142-n may press a “jump back” button on a remote control after the seventh line of dialog is spoken. Based on this user input and a seek parameter 100-p indicating that the “jump back” button, when pressed, should seek to an immediately previous line of dialog, content management module 106 may determine a seek destination 108 comprising the seventh line of dialog. Content management module 106 may then access content description database 200 and identify content description information entry 202-1, which corresponds to the seventh line of dialog, as corresponding to the determined seek destination 108. Content management module 106 may then identify the time index value 202-1-2 equal to 0:33:41.27 comprised within content description information entry 202-1, and seek to that time index value. The embodiments are not limited to this example.

In some embodiments, with reference to FIG. 1, content management module 106, content presentation application 105, and/or one or more external components may be operative to determine a seek destination 108 based on content description information entries 202-s in conjunction with a guided seek operation. In an example embodiment, a user viewing a content item 150 on a content presentation device 142-n may enter inputs via an input device 143 indicating that he wishes to search for events 154-r during which the character Jane is present. Based on this user input, content management module 106 may access content description database 200 and identify entries 202-2 and 202-3 as corresponding to events 154-r during which Jane is present, based on event description information 202-2-1 and 202-3-1, respectively. Content management module 106 may then be operative to present the events 154-r comprising the third entry of the character Jill and the beginning of the song “Happy Birthday to You” as options for selection using a graphical user interface. Content management module 106 may then receive a selection of the event 154-r comprising the third entry of the character Jill. Content management module 106 may then identify the time index value 202-2-2 equal to 0:49:12.87 comprised within content description information entry 202-2, and seek to that time index value. The embodiments are not limited to this example.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited in this context.

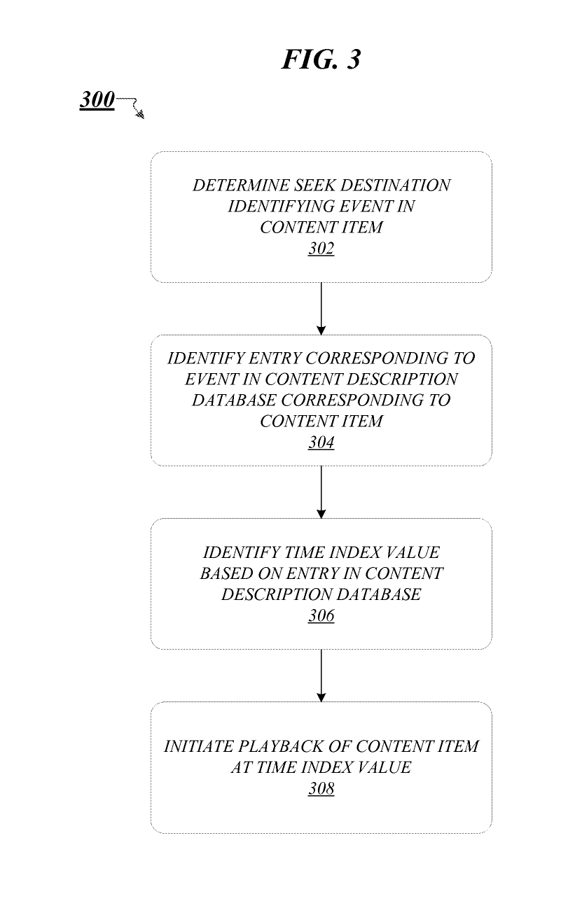

FIG. 3 illustrates one embodiment of a logic flow 300, which may be representative of the operations executed by one or more embodiments described herein. As shown in logic flow 300, a seek destination identifying an event in a content item may be determined at 302. For example, content management module 106 of FIG. 1 may determine a seek destination 108 identifying an event 154-r in a content item 150. At 304, an entry corresponding to the event may be identified in a content description database corresponding to the content item. For example, content management module 106 of FIG. 1 may identify a content description information entry 114-s corresponding to the event 154-r in a content description database 112 corresponding to the content item 150. At 306, a time index value corresponding to the event may be identified based on the entry in the content description database. For example, content management module 106 of FIG. 1 may identify a time index value 152-q corresponding to the event 154-r based on the content description information entry 114-s. In various embodiments, the entry in the content description database may comprise event-time correspondence information, and the time index value may be identified based on the event-time correspondence information. For example, the content description information entry 114-s identified by content management module 106 of FIG. 1 may comprise event-time correspondence information 114-s-2, and content management module 106 may identify the time index value 152-q based on the event-time correspondence information 114-s-2. At 308, playback of the content item may be initiated at the time index value. For example, content management module 106 may initiate playback of the content item 150 at the time index value 152-q. The embodiments are not limited to these examples.

FIG. 4 illustrates one embodiment of a logic flow 400, which may be representative of operations performed in conjunction with a first method for generating a content description database such as content description database 112 of FIG. 1 and/or content description database 200 of FIG. 2. As noted above, in some embodiments, apparatus 100 and/or system 140 may be operative to generate a content description database, while in other embodiments, the content description database may be externally generated and simply accessed by apparatus 100 and/or system 140. Logic flow 400 may be representative of operations performed in conjunction with a method for generating a content description database by analyzing the video and/or audio effects associated with a content item and detecting events based on this analysis. As shown in logic flow 400, a content item may be received at 402. For example, apparatus 100 and/or system 140 of FIG. 1 may receive content item 150. At 404, a time index counter may be initialized. For example, content management module 106 of FIG. 1 may initialize a time index counter. At 406, a check may be performed for events in the content item at a time index value equal to the time index counter. For example, content management module 106 may perform a check for events 154-r in content item 150 at a time index value 152-q equal to the time index counter. In various embodiments, performing a check for events 154-r in a content item 150 at a time index value 152-q may comprise performing one or more event-detection algorithms. Each event-detection algorithm may comprise logic, information, or instructions for determining whether an event 154-r occurs in the content item 150 at the time index value 152-q. An example event-detection algorithm may comprise logic, information, or instructions operative to analyze visual data associated with content item 150 at time index value 152-q, determine the characters present on the screen at time index value 152-q, determine whether any such characters were not present on the screen at an immediately previous time index value 152-q, and identify, for any character not present on the screen at the immediately previous time index value 152-q, an event 154-r corresponding to the entry of that character onto the screen. The embodiments are not limited to this example.

Continuing with the description of logic flow 400, at 408, it may be determined whether one or more events have been found in the content item at the time index value equal to the time index counter. For example, content management module 106 may determine whether one or more events 154-r have been found in the content item 150 at the time index value 152-q equal to the time index counter. If it is determined that one or more events have been found in the content item at the time index value equal to the time index counter, flow may pass to 410. At 410, an entry may be created in a content description database for each of the one or more events. For example, content management module 106 may create an entry 114-s in content description database 112 for each of the one or more events 154-r found in the content item 150 at the time index value 152-q equal to the time index counter. Flow may then pass to 412. If, at 408, it is determined that no events have been found in the content item at the time index value equal to the time index counter, flow may pass directly from 408 to 412.

At 412, it may be determined whether all time index values have been processed. In some embodiments, determining whether all time index values have been processed may comprise determining whether the time index counter exceeds a last time index value or duration of the content item. For example, content management module 106 may determine whether the time index counter exceeds a last time index value 152-q of content item 150. If it is determined that all time index values have not been processed, flow may pass to 414, where the time index counter may be incremented, and then back to 406, where a check may be performed for events in the content item at a time index value equal to the incremented time index counter. If it is determined at 412 that all time index values have been processed, the logic flow may end.

FIG. 5 illustrates one embodiment of a logic flow 500, which may be representative of operations performed in conjunction with a second method for generating a content description database such as content description database 112 of FIG. 1 and/or content description database 200 of FIG. 2. Logic flow 500 may be representative of operations performed in conjunction with a method for generating a content description database by analyzing content metadata elements associated with a content item, and detecting events based on these content metadata elements. Such content metadata elements may comprise information, data, or logic describing characteristics of the content item. In various embodiments, such content metadata elements may be stored with and/or embedded within the content item. For example, in some embodiments, such content metadata elements may comprise subtitle information and/or closed captioning information embedded in a content item. The embodiments are not limited to these examples.

As shown in FIG. 5, at 502, one or more content metadata elements may be received. For example, content management module 106 of FIG. 1 may receive one or more content metadata elements comprising subtitle information embedded in content item 150, where each content metadata element comprises a particular subtitle. At 504, a content metadata element may be selected. For example, content management module 106 of FIG. 1 may select a content metadata element comprising a particular subtitle from among the subtitle information embedded in content item 150. At 506, content description information and a time index value of the content metadata element may be determined. For example, content management module 106 of FIG. 1 may determine content description information comprising the words in a line of dialog corresponding to the particular subtitle and a time index value corresponding to the particular subtitle. At 508, an entry may be created in a content description database, the entry comprising the content description information and the time index value. For example, content management module 106 of FIG. 1 may create an entry 112-s in content description database 112 comprising the words in the line of dialog corresponding to the particular subtitle and the time index value corresponding to the particular subtitle.

At 510, it may be determined whether all of the one or more content metadata elements have been processed. For example, content management module 106 of FIG. 1 may determine whether each subtitle comprised within the subtitle information has been processed. If it is determined that all of the one or more content metadata elements have not been processed, flow may return to 504, where a new content metadata element may be selected. If it is determined that all of the one or more content metadata elements have been processed, the logic flow may end.

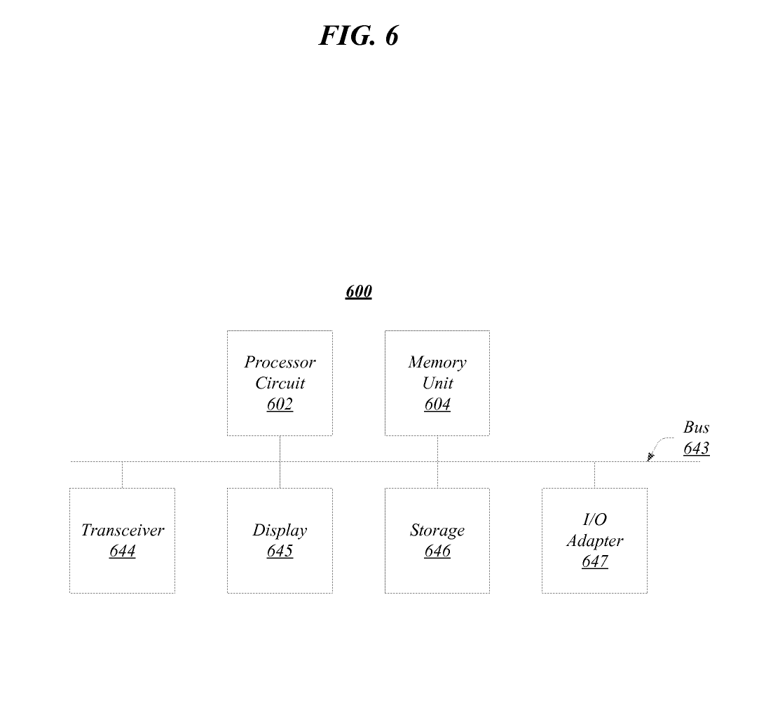

FIG. 6 illustrates one embodiment of a system 600. In various embodiments, system 600 may be representative of a system or architecture suitable for use with one or more embodiments described herein, such as apparatus 100 and/or system 140 of FIG. 1, logic flow 300 of FIG. 3, logic flow 400 of FIG. 4, and/or logic flow 500 of FIG. 5. The embodiments are not limited in this respect.

As shown in FIG. 6, system 600 may include multiple elements. One or more elements may be implemented using one or more circuits, components, registers, processors, software subroutines, modules, or any combination thereof, as desired for a given set of design or performance constraints. Although FIG. 6 shows a limited number of elements in a certain topology by way of example, it can be appreciated that more or less elements in any suitable topology may be used in system 600 as desired for a given implementation. The embodiments are not limited in this context.

In various embodiments, system 600 may include a processor circuit 602. Processor circuit 602 may be implemented using any processor or logic device, and may be the same as or similar to processor circuit 102 of FIG. 1.

In one embodiment, system 600 may include a memory unit 604 to couple to processor circuit 602. Memory unit 604 may be coupled to processor circuit 602 via communications bus 643, or by a dedicated communications bus between processor circuit 602 and memory unit 604, as desired for a given implementation. Memory unit 604 may be implemented using any machine-readable or computer-readable media capable of storing data, including both volatile and non-volatile memory, and may be the same as or similar to memory unit 104 of FIG. 1. In some embodiments, the machine-readable or computer-readable medium may include a non-transitory medium. The embodiments are not limited in this context.

In various embodiments, system 600 may include a transceiver 644. Transceiver 644 may include one or more radios capable of transmitting and receiving signals using various suitable wireless communications techniques, and may be the same as or similar to transceiver 144 of FIG. 1.

In various embodiments, system 600 may include a display 645. Display 645 may constitute any display device capable of displaying information received from processor circuit 602. Examples for display 645 may include a television, a monitor, a projector, and a computer screen. In one embodiment, for example, display 645 may be implemented by a liquid crystal display (LCD), light emitting diode (LED) or other type of suitable visual interface. Display 645 may constitute, for example, a touch-sensitive color display screen. In various implementations, display 645 may include one or more thin-film transistors (TFT) LCD including embedded transistors. In various embodiments, display 645 may be arranged to display a graphical user interface operable to directly or indirectly control a graphics processing application, such as content management application 105 in FIG. 1, for example. The embodiments are not limited in this context.

In various embodiments, system 600 may include storage 646. Storage 646 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 646 may include technology to increase the storage performance enhanced protection for valuable digital media when multiple hard drives are included, for example. Further examples of storage 646 may include a hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of DVD devices, a tape device, a cassette device, or the like. The embodiments are not limited in this context.

In various embodiments, system 600 may include one or more I/O adapters 647. Examples of I/O adapters 647 may include Universal Serial Bus (USB) ports/adapters, IEEE 1394 Firewire ports/adapters, and so forth. The embodiments are not limited in this context.

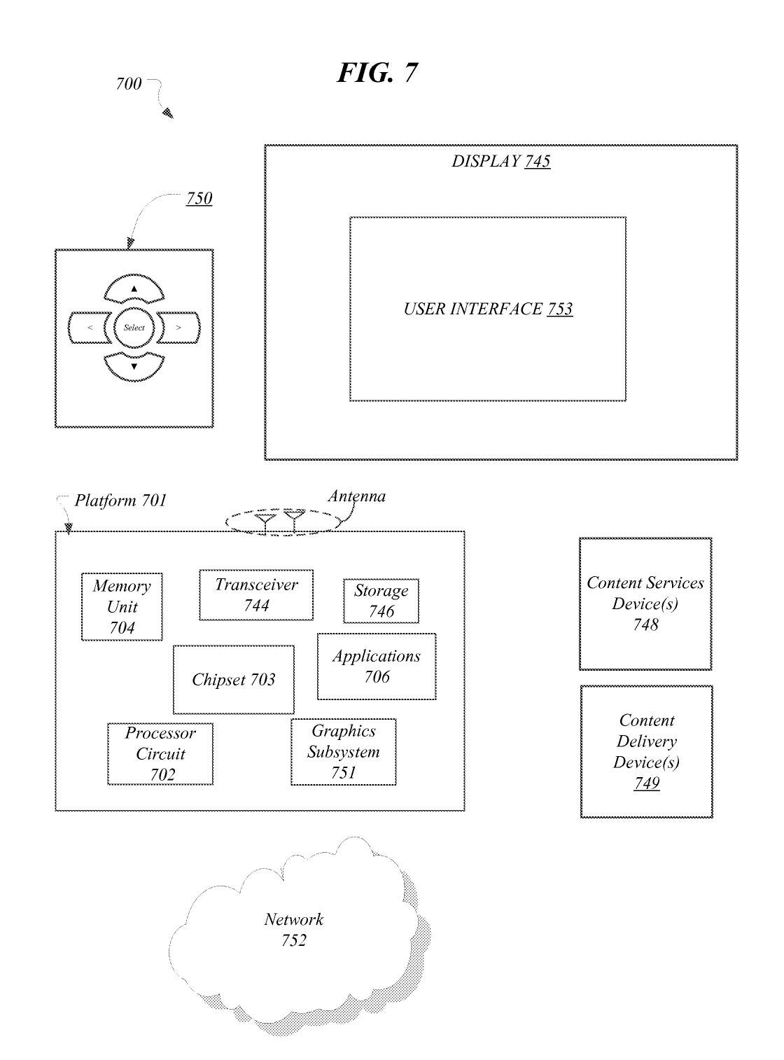

FIG. 7 illustrates an embodiment of a system 700. In various embodiments, system 700 may be representative of a system or architecture suitable for use with one or more embodiments described herein, such as apparatus 100 and/or system 140 of FIG. 1, logic flow 300 of FIG. 3, logic flow 400 of FIG. 4, logic flow 500 of FIG. 5, and/or system 600 of FIG. 6. The embodiments are not limited in this respect.

As shown in FIG. 7, system 700 may include multiple elements. One or more elements may be implemented using one or more circuits, components, registers, processors, software subroutines, modules, or any combination thereof, as desired for a given set of design or performance constraints. Although FIG. 7 shows a limited number of elements in a certain topology by way of example, it can be appreciated that more or less elements in any suitable topology may be used in system 700 as desired for a given implementation. The embodiments are not limited in this context.

In embodiments, system 700 may be a media system although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 700 includes a platform 701 coupled to a display 745. Platform 701 may receive content from a content device such as content services device(s) 748 or content delivery device(s) 749 or other similar content sources. A navigation controller 750 including one or more navigation features may be used to interact with, for example, platform 701 and/or display 745. Each of these components is described in more detail below.

In embodiments, platform 701 may include any combination of a processor circuit 702, chipset 703, memory unit 704, transceiver 744, storage 746, applications 751, and/or graphics subsystem 752. Chipset 703 may provide intercommunication among processor circuit 702, memory unit 704, transceiver 744, storage 746, applications 751, and/or graphics subsystem 752. For example, chipset 703 may include a storage adapter (not depicted) capable of providing intercommunication with storage 746.

Processor circuit 702 may be implemented using any processor or logic device, and may be the same as or similar to processor circuit 602 in FIG. 6.

Memory unit 704 may be implemented using any machine-readable or computer-readable media capable of storing data, and may be the same as or similar to memory unit 604 in FIG. 6.

Transceiver 744 may include one or more radios capable of transmitting and receiving signals using various suitable wireless communications techniques, and may be the same as or similar to transceiver 644 in FIG. 6.

Display 745 may include any television type monitor or display, and may be the same as or similar to display 645 in FIG. 6.

Storage 746 may be implemented as a non-volatile storage device, and may be the same as or similar to storage 646 in FIG. 6.

Graphics subsystem 752 may perform processing of images such as still or video for display. Graphics subsystem 752 may be a graphics processing unit (GPU) or a visual processing unit (VPU), for example. An analog or digital interface may be used to communicatively couple graphics subsystem 752 and display 745. For example, the interface may be any of a High-Definition Multimedia Interface, DisplayPort, wireless HDMI, and/or wireless HD compliant techniques. Graphics subsystem 752 could be integrated into processor circuit 702 or chipset 703. Graphics subsystem 752 could be a stand-alone card communicatively coupled to chipset 703.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

In embodiments, content services device(s) 748 may be hosted by any national, international and/or independent service and thus accessible to platform 701 via the Internet, for example. Content services device(s) 748 may be coupled to platform 701 and/or to display 745. Platform 701 and/or content services device(s) 748 may be coupled to a network 753 to communicate (e.g., send and/or receive) media information to and from network 753. Content delivery device(s) 749 also may be coupled to platform 701 and/or to display 745.

In embodiments, content services device(s) 748 may include a cable television box, personal computer, network, telephone, Internet enabled devices or appliance capable of delivering digital information and/or content, and any other similar device capable of unidirectionally or bidirectionally communicating content between content providers and platform 701 and/display 745, via network 753 or directly. It will be appreciated that the content may be communicated unidirectionally and/or bidirectionally to and from any one of the components in system 700 and a content provider via network 753. Examples of content may include any media information including, for example, video, music, medical and gaming information, and so forth.

Content services device(s) 748 receives content such as cable television programming including media information, digital information, and/or other content. Examples of content providers may include any cable or satellite television or radio or Internet content providers. The provided examples are not meant to limit embodiments of the invention.

In embodiments, platform 701 may receive control signals from navigation controller 750 having one or more navigation features. The navigation features of navigation controller 750 may be used to interact with a user interface 754, for example. In embodiments, navigation controller 750 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of navigation controller 750 may be echoed on a display (e.g., display 745) by movements of a pointer, cursor, focus ring, or other visual indicators displayed on the display. For example, under the control of software applications 751, the navigation features located on navigation controller 750 may be mapped to virtual navigation features displayed on user interface 754. In embodiments, navigation controller 750 may not be a separate component but integrated into platform 701 and/or display 745. Embodiments, however, are not limited to the elements or in the context shown or described herein.

In embodiments, drivers (not shown) may include technology to enable users to instantly turn on and off platform 701 like a television with the touch of a button after initial boot-up, when enabled, for example. Program logic may allow platform 701 to stream content to media adaptors or other content services device(s) 748 or content delivery device(s) 749 when the platform is turned “off.” In addition, chip set 703 may include hardware and/or software support for 5.1 surround sound audio and/or high definition 7.1 surround sound audio, for example. Drivers may include a graphics driver for integrated graphics platforms. In embodiments, the graphics driver may include a peripheral component interconnect (PCI) Express graphics card.

In various embodiments, any one or more of the components shown in system 700 may be integrated. For example, platform 701 and content services device(s) 748 may be integrated, or platform 701 and content delivery device(s) 749 may be integrated, or platform 701, content services device(s) 748, and content delivery device(s) 749 may be integrated, for example. In various embodiments, platform 701 and display 745 may be an integrated unit. Display 745 and content service device(s) 748 may be integrated, or display 745 and content delivery device(s) 749 may be integrated, for example. These examples are not meant to limit the invention.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as I/0 adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 701 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 7.

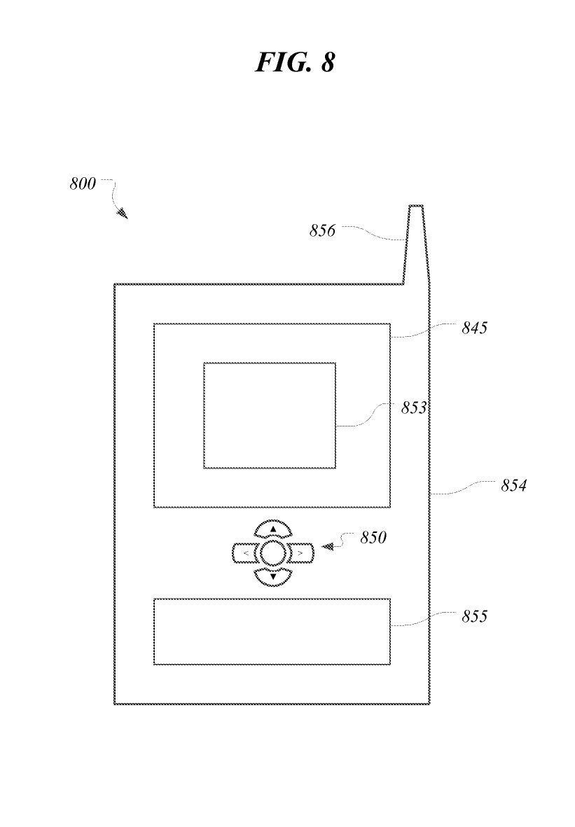

As described above, system 700 may be embodied in varying physical styles or form factors. FIG. 8 illustrates embodiments of a small form factor device 800 in which system 700 may be embodied. In embodiments, for example, device 800 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 8, device 800 may include a display 845, a navigation controller 850, a user interface 854, a housing 855, an I/O device 856, and an antenna 857. Display 845 may include any suitable display unit for displaying information appropriate for a mobile computing device, and may be the same as or similar to display 745 in FIG. 7. Navigation controller 850 may include one or more navigation features which may be used to interact with user interface 854, and may be the same as or similar to navigation controller 750 in FIG. 7. I/O device 856 may include any suitable I/O device for entering information into a mobile computing device. Examples for I/O device 856 may include an alphanumeric keyboard, a numeric keypad, a touch pad, input keys, buttons, switches, rocker switches, microphones, speakers, voice recognition device and software, and so forth. Information also may be entered into device 800 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The following examples pertain to further embodiments:

An apparatus may comprise a processor circuit, a memory unit, and a content management module operative on the processor circuit to determine a seek destination comprising an event within a content item, identify a time index value corresponding to the event, and initiate playback of the content item at the time index value.

With respect to such an apparatus, the content management module may be operative to identify an entry corresponding to the event in a content description database corresponding to the content item and identify the time index value based on the entry corresponding to the event.

With respect to such an apparatus, the entry in the content description database may comprise event-time correspondence information, and the content management module may be operative to identify the time index value based on the event-time correspondence information.

With respect to such an apparatus, the content management module may be operative to receive input from an input device and determine the seek destination based on the input.

With respect to such an apparatus, the seek destination may comprise a line of dialog.

With respect to such an apparatus, the seek destination may comprise an entry of a character into a scene, an exit of the character from a scene.

With respect to such an apparatus, the content management module may be operative to determine one or more seek parameters based on the input and determine the seek destination based on the one or more seek parameters.

With respect to such an apparatus, the content management module may be operative to identify one or more entries in a content description database based on the one or more seek parameters, present one or more events for selection in a graphical user interface, receive a selection of one of the one or more events, and determine the seek destination based on the selection of the one of the one or more events

A computer-implemented method may comprise determining, by a processor circuit, a seek destination comprising an event within a content item, identifying a time index value corresponding to the event, and initiating playback of the content item at the time index value.

Such a computer-implemented method may comprise identifying an entry corresponding to the event in a content description database corresponding to the content item and identifying the time index value based on the entry corresponding to the event.

With respect to such a computer-implemented method, the entry in the content description database may comprise event-time correspondence information, and the computer-implemented method may comprise identifying the time index value based on the event-time correspondence information.

Such a computer-implemented method may comprise receiving input from an input device and determining the seek destination based on the input.

With respect to such a computer-implemented method, the seek destination may comprise a line of dialog.

With respect to such a computer-implemented method, the seek destination may comprise an entry of a character into a scene or an exit of the character from a scene.

Such a computer-implemented method may comprise determining one or more seek parameters based on the input and determining the seek destination based on the one or more seek parameters.

Such a computer-implemented method may comprise identifying one or more entries in a content description database based on the one or more seek parameters, presenting one or more events for selection in a graphical user interface, receiving a selection of one of the one or more events, and determining the seek destination based on the selection of the one of the one or more events.

A communications device may be arranged to perform such a computer-implemented method.

At least one machine-readable medium may comprise instructions that, in response to being executed on a computing device, cause the computing device to carry out such a computer-implemented method.

An apparatus may comprise means for performing such a computer-implemented method.

At least one machine-readable medium may comprise a plurality of instructions that, in response to being executed on a computing device, cause the computing device to determine a seek destination comprising an event within a content item, identify a time index value corresponding to the event, and initiate playback of the content item at the time index value.

Such at least one machine-readable medium may comprise instructions that, in response to being executed on the computing device, cause the computing device to identify an entry corresponding to the event in a content description database corresponding to the content item and identify the time index value based on the entry corresponding to the event.

With respect to such at least one machine-readable medium, the entry in the content description database may comprise event-time correspondence information, and the at least one machine-readable medium may comprise instructions that, in response to being executed on the computing device, cause the computing device to identify the time index value based on the event-time correspondence information.

Such at least one machine-readable medium may comprise instructions that, in response to being executed on the computing device, cause the computing device to receive input from an input device and determine the seek destination based on the input.

With respect to such at least one machine-readable medium, the seek destination may comprise a line of dialog.

With respect to such at least one machine-readable medium, the seek destination may comprise an entry of a character into a scene or an exit of the character from a scene.

Such at least one machine-readable medium may comprise instructions that, in response to being executed on the computing device, cause the computing device to determine one or more seek parameters based on the input and determine the seek destination based on the one or more seek parameters.

Such at least one machine-readable medium may comprise instructions that, in response to being executed on the computing device, cause the computing device to identify one or more entries in a content description database based on the one or more seek parameters, present one or more events for selection in a graphical user interface, receive a selection of one of the one or more events, and determine the seek destination based on the selection of the one of the one or more events.

A computer-implemented method may comprise receiving one or more content metadata elements corresponding to a content item, selecting, by a processor circuit, a content metadata element from among the one or more content metadata elements, determining a time index value based on the content metadata element, and creating an entry in a content description database based on the content metadata element, the entry comprising the time index value.

Such a computer-implemented method may comprise determining content description information based on the content metadata element and creating the entry in the content description database based on the content metadata element, the entry comprising the content description information.

With respect to such a computer-implemented method, the one or more content metadata elements may comprise subtitle information embedded in the content item.

With respect to such a computer-implemented method, the one or more content metadata elements may comprise closed captioning information embedded within a broadcast of the content item.

Such a computer-implemented method may comprise determining a seek destination comprising an event corresponding to the content metadata element.

Such a computer-implemented method may comprise identifying the time index value in the entry in the content description database based on the seek destination and initiating playback of the content item at the time index value.

A communications device may be arranged to perform such a computer-implemented method.

At least one machine-readable medium may comprise instructions that, in response to being executed on a computing device, cause the computing device to carry out such a computer-implemented method.

An apparatus may comprise means for performing such a computer-implemented method.

Numerous specific details have been set forth herein to provide a thorough understanding of the embodiments. It will be understood by those skilled in the art, however, that the embodiments may be practiced without these specific details. In other instances, well-known operations, components, and circuits have not been described in detail so as not to obscure the embodiments. It can be appreciated that the specific structural and functional details disclosed herein may be representative and do not necessarily limit the scope of the embodiments.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It should be noted that the methods described herein do not have to be executed in the order described, or in any particular order. Moreover, various activities described with respect to the methods identified herein can be executed in serial or parallel fashion.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

It is emphasized that the Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the respective terms “comprising” and “wherein,” respectively. Moreover, the terms “first,” “second,” and “third,” etc. are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus, comprising:
a processor circuit;
a memory unit; and
a content management module operative on the processor circuit to:
determine a seek destination comprising an event within a content item;
identify a time index value corresponding to the event; and
initiate playback of the content item at the time index value.

2. The apparatus of claim 1, the content management module operative to:
identify an entry corresponding to the event in a content description database corresponding to the content item; and
identify the time index value based on the entry corresponding to the event.

3. The apparatus of claim 2, the entry in the content description database comprising event-time correspondence information, the content management module operative to identify the time index value based on the event-time correspondence information.

4. The apparatus of claim 1, the content management module operative to:
receive input from an input device; and
determine the seek destination based on the input.

5. The apparatus of claim 4, the seek destination comprising a line of dialog.

6. The apparatus of claim 4, the seek destination comprising an entry of a character into a scene or an exit of the character from a scene.

7. The apparatus of claim 4, the content management module operative to:
determine one or more seek parameters based on the input; and
determine the seek destination based on the one or more seek parameters.

8. The apparatus of claim 7, the content management module operative to:
identify one or more entries in a content description database based on the one or more seek parameters;
present one or more events for selection in a graphical user interface;
receive a selection of one of the one or more events; and
determine the seek destination based on the selection of the one of the one or more events.

9. A computer-implemented method, comprising:
determining, by a processor circuit, a seek destination comprising an event within a content item;
identifying a time index value corresponding to the event; and
initiating playback of the content item at the time index value.

10. The computer-implemented method of claim 9, comprising:
identifying an entry corresponding to the event in a content description database corresponding to the content item; and
identifying the time index value based on the entry corresponding to the event.

11. The computer-implemented method of claim 10, the entry in the content description database comprising event-time correspondence information, the method comprising identifying the time index value based on the event-time correspondence information.

12. The computer-implemented method of claim 11, comprising:
receiving input from an input device; and
determining the seek destination based on the input.

13. The computer-implemented method of claim 12, the seek destination comprising a line of dialog.

14. The computer-implemented method of claim 12, the seek destination comprising an entry of a character into a scene or an exit of the character from a scene.

15. The computer-implemented method of claim 12, comprising:
determining one or more seek parameters based on the input; and
determining the seek destination based on the one or more seek parameters.

16. The computer-implemented method of claim 15, comprising:
identifying one or more entries in a content description database based on the one or more seek parameters;
presenting one or more events for selection in a graphical user interface;
receiving a selection of one of the one or more events; and
determining the seek destination based on the selection of the one of the one or more events.

17. At least one machine-readable medium comprising a plurality of instructions that, in response to being executed on a computing device, cause the computing device to:
determine a seek destination comprising an event within a content item;
identify a time index value corresponding to the event; and
initiate playback of the content item at the time index value.

18. The at least one machine-readable medium of claim 17, comprising instructions that, in response to being executed on the computing device, cause the computing device to:
identify an entry corresponding to the event in a content description database corresponding to the content item; and
identify the time index value based on the entry corresponding to the event.

19. The at least one machine-readable medium of claim 18, the entry in the content description database comprising event-time correspondence information, the at least one machine-readable medium comprising instructions that, in response to being executed on the computing device, cause the computing device to identify the time index value based on the event-time correspondence information.

20. The at least one machine-readable medium of claim 17, comprising instructions that, in response to being executed on the computing device, cause the computing device to:
receive input from an input device; and
determine the seek destination based on the input.

21. The at least one machine-readable medium of claim 20, the seek destination comprising a line of dialog.

22. The at least one machine-readable medium of claim 20, the seek destination comprising an entry of a character into a scene or an exit of the character from a scene.

23. The at least one machine-readable medium of claim 20, comprising instructions that, in response to being executed on the computing device, cause the computing device to:
determine one or more seek parameters based on the input; and
determine the seek destination based on the one or more seek parameters.

24. The at least one machine-readable medium of claim 23, comprising instructions that, in response to being executed on the computing device, cause the computing device to:
identify one or more entries in a content description database based on the one or more seek parameters;
present one or more events for selection in a graphical user interface;
receive a selection of one of the one or more events; and
determine the seek destination based on the selection of the one of the one or more events.

25. A computer-implemented method, comprising:
receiving one or more content metadata elements corresponding to a content item;
selecting, by a processor circuit, a content metadata element from among the one or more content metadata elements;
determining a time index value based on the content metadata element; and
creating an entry in a content description database based on the content metadata element, the entry comprising the time index value.

26. The computer-implemented method of claim 25, comprising:
determining content description information based on the content metadata element; and
creating the entry in the content description database based on the content metadata element, the entry comprising the content description information.

27. The computer-implemented method of claim 25, the one or more content metadata elements comprising subtitle information embedded in the content item.

28. The computer-implemented method of claim 25, the one or more content metadata elements comprising closed captioning information embedded within a broadcast of the content item.

29. The computer-implemented method of claim 25, comprising determining a seek destination comprising an event corresponding to the content metadata element.

30. The computer-implemented method of claim 29, comprising:
identifying the time index value in the entry in the content description database based on the seek destination; and
initiating playback of the content item at the time index value.
